(19) United States
(12) Patent Application Publication
(10) Pub. No.: US 2010/0208068 A1
(43) Pub. Date: Aug. 19, 2010

(54) SURVEILLANCE CAMERA APPARATUS, REMOTE RETRIEVAL AND MOUNTING BRACKET THEREFOR

(76) Inventor: Perry Elsemore, Saxon, IN (US)

Correspondence Address: BRIGGS AND MORGAN P.A., 2200 IDS CENTER, 80 SOUTH 8TH ST, MINNEAPOLIS, MN, 55402, US

(21) Appl. No.: 12/707,434

(22) Filed: Feb. 17, 2010

Related U.S. Application Data
(63) Continuation-in-part of application No. 11/956,063, filed on Dec. 13, 2007.
Application No. 11/956,063 is a continuation-in-part of application No. 29/283,278, filed on Aug. 9, 2007, now abandoned.
Application No. 29/283,278 is a continuation-in-part of application No. 29/275,293, filed on Dec. 20, 2006, now Pat. No. D586249.
(60) Provisional application No. 61/153,256, filed on Feb. 17, 2009.
(60) Provisional application No. 60/870,952, filed on Dec. 20, 2006.

(51) Int. Cl. H04N 7/18

(52) U.S. Cl. 348/143; 348/E07.091

(57) ABSTRACT

A digital image recording surveillance camera apparatus and system for 24-hour home or business security, surveillance, or to monitor and detect animal movement. The apparatus has a camera, which when activated, photographs an object entering a heat-in-motion detection zone. The apparatus includes a passive IR sensor, multiple infrared emitting diodes, image storage, radio frequency transmission and reception, a remote control and image retrieving device and a tree mounting bracket therefor.

### CROSS-REFERENCE TO RELATED APPLICATIONS

The present application claims the benefit of U.S. Provisional Patent Application Ser. No. 61/153,256 filed Feb. 17, 2009 and is a continuation-in-part of U.S. Utility patent application Ser. No. 11/956,063 filed Dec. 13, 2007 which claims the benefit of U.S. Provisional Patent Application Ser. No. 60/870,952 filed Dec. 20, 2006 and is a continuation-in-part of U.S. Design patent application Ser. No. 29/283,278 filed Aug. 9, 2007, now abandoned, which is a continuation-in-part of U.S. Design patent application Ser. No. 29/275,293 filed Dec. 20, 2006, now U.S. Pat. No. D586,249 issued Feb. 10, 2009.

### BACKGROUND OF THE INVENTION

The present invention relates to a novel and unique surveillance camera apparatus, remote retrieval device and mounting bracket therefor.

The prior, but not necessarily relevant, art is exemplified by:

Nakamura U.S. Pat. No. 5,133,605;

Smoot U.S. Pat. No. 5,940,139;

Midgley et al. U.S. Pat. No. 6,642,955;

Huster United States Patent Application Publication 2005/0212912;

Lungershausen et al. U.S. Pat. No. 5,701,015;

Olczak et al. U.S. Pat. No. 6,275,256; and

Park US Patent Application Publn. US2007/0019077.

The present invention solves the prior art problems and other problems, and also provides an apparatus and system which can be used full-time under all types of light conditions, day and night. The present invention provides a very energy-efficient surveillance camera apparatus remote retrieval device and mounting bracket therefor.

### SUMMARY OF THE INVENTION

The invention provides a self-contained surveillance camera apparatus that does not require remote sensors, this self-contained surveillance camera system not only can store images and videos internally but also has the ability to send images and videos to an offsite Hi-Output RF communication receiver. Using multiple camera systems at the same time are contemplated—each image sending capabilities to an off-site RF receiver that could be several miles away. The apparatus includes: a water-tight case; a camera mounted in the case; a digital imaging engine mounted in the case; a battery supply mounted either externally or internally in the case; one or more infrared emitting diodes mounted in the case; one or more passive infrared sensors mounted in the case; a light sensor mounted in the case; a wireless circuit board antenna mounted externally or internally in the case; a USB mass storage device mounted in the case; a day/night exchanger mounted in the case; a sd or compact flash card mounted in the case; and the digital imaging engine being operably connected to the camera, the battery supply, the infrared diodes, the passive infrared sensors, the antenna, the mass storage device, the day/night exchanger, and the sd or compact flash card; and whereby the camera is enabled to take a photographic or video image of an external object entering a heat-in-motion detection zone.

The invention also provides a surveillance system, comprising: one or more wireless remote sensors which each send an infrared transmission signal configured into a separate conical array forming a heat-in-motion detection zone; a surveillance apparatus having a 360-degree dome mounted camera; wireless transmission means for transmitting a signal from said remote sensor to said apparatus indicative of an external object entering the detection zone; and means in the apparatus causing the camera to rotate to face in the direction of the object and to photograph the object.

The invention also provides the advantages of invisible 900-950 nm infrared emitting diodes (IEDs) and longer distance 830 nm IEDs for a broad range of applications.

A unique mounting bracket system is also provided with enhanced security features.

Other objects, advantages, and features of the present invention will become apparent to those persons skilled in this particular area of technology and to other persons after having been exposed to the present patent application when read in conjunction with the accompanying patent drawings.

### BRIEF DESCRIPTION OF THE DRAWINGS

FIG. 1 is a rear perspective view of a self-contained surveillance camera apparatus in accordance with a first embodiment of the present invention with invisible 900-950 nm IEDs.

FIG. 2 is a side evaluational view as viewed from the right of the apparatus as depicted in FIG. 1.

FIG. 3 is a front elevational view thereof.

FIG. 4 is a side elevational view as viewed from the left of the apparatus as depicted in FIG. 1.

FIG. 5 is a rear elevational thereof.

FIG. 6 is a top plan view thereof.

FIG. 7 is a bottom view thereof.

FIG. 8 illustrates a second embodiment of the invention with remote sensors and a 360 degree dome camera.

FIG. 9 is a composite schematic block diagram for explaining the interconnnection system for using first and second embodiments of the invention

FIG. 10 is a front perspective view of a self-contained surveillance camera apparatus in accordance with a third embodiment of the present invention that does not require remote sensors and uses multiple range IEDs. This apparatus does have the ability to communicate with a wireless transmitter over long distances using but limited to the DIGI XBee Pro XSC embedded Hi-Output Rf system and includes game calls.

FIG. 11 is a front elevational view of the FIG. 10 apparatus.

FIG. 12 is a rear perspective view of the FIG. 10 apparatus.

FIG. 13 is a right side elevational view of the FIG. 10 apparatus.

FIG. 14 is a rear elevational view of the FIG. 10 apparatus.

FIG. 15 is a schematic diagram of a wireless transmitter and some features of the third embodiment.

FIG. 16 is a front perspective view of camera mounted on a tree bracket.

FIG. 17 is a rear perspective view of the camera of FIG. 16.

FIG. 18 is a front elevational view of the tree bracket of FIG. 16.

FIG. 19 is a rear perspective view of the bracket of FIG. 16.

FIG. 20 is a right side elevational view of a bottom mounted camera and bracket of FIG. 16.

FIG. 21 is a right side elevational view of a top mounted camera and bracket of FIG. 16.

FIG. 22 is a perspective view of a battery held by a tree bracket.

FIGS. 23 and 24 show the top and bottom battery caps, respectively, of FIG. 22.

FIGS. 25-27 show how the battery caps interlock with the tree bracket.

FIG. 28 is a schematic diagram of a RF transmitter and some portions of the other embodiments.

FIG. 29 is a schematic diagram of a fourth embodiment of the RF camera system.

### DETAILED DESCRIPTION OF THE INVENTION

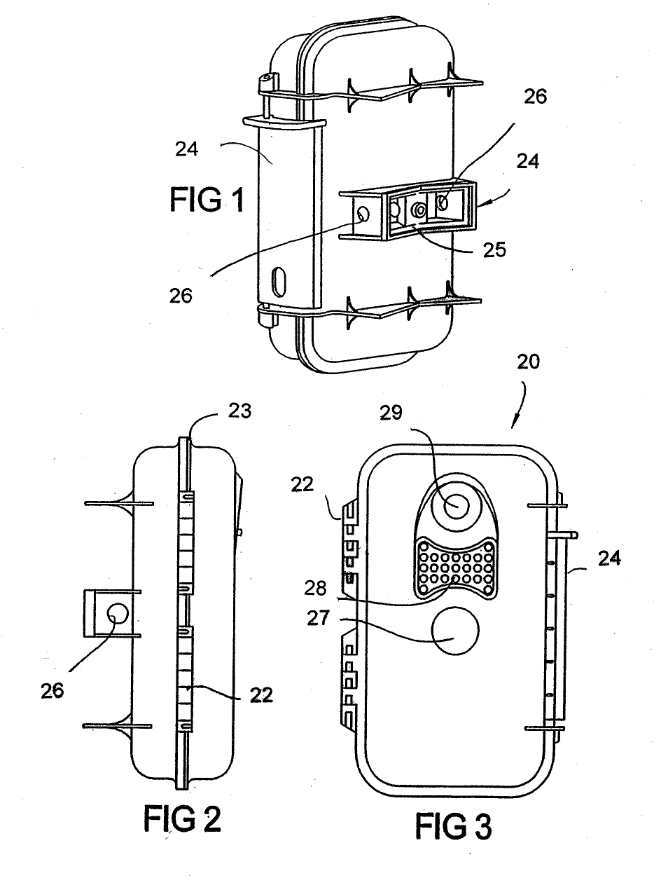

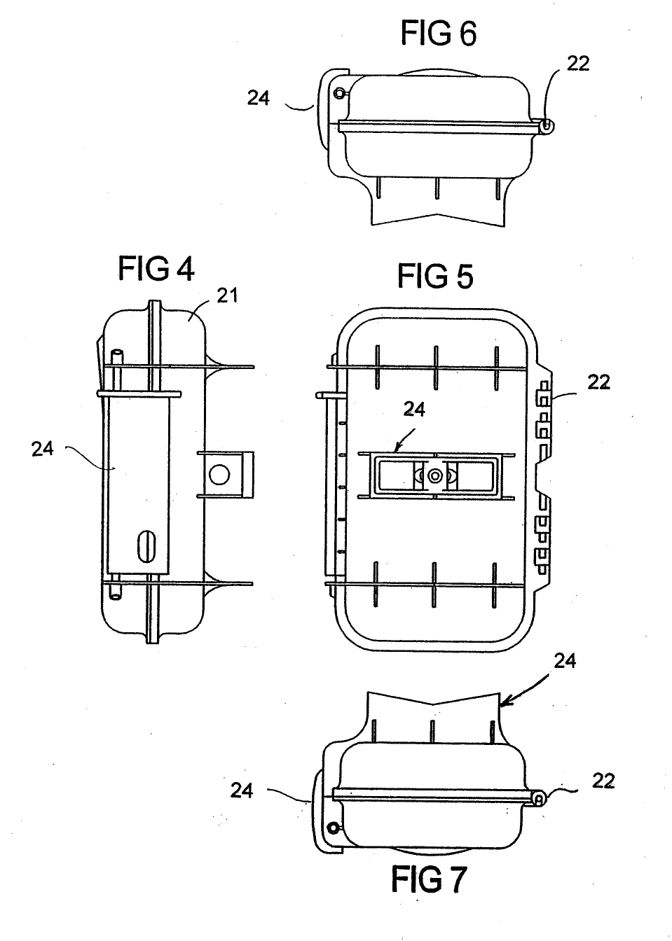

The present invention provides a digital image recording surveillance apparatus 20 and system for 24-hour home or business security, surveillance, and/or to monitor and detect animal movement. FIGS. 1-7 illustrate a self-contained surveillance system/apparatus 20 in accordance with a first embodiment which may readily be mounted on an external structure, for example, on a tree.

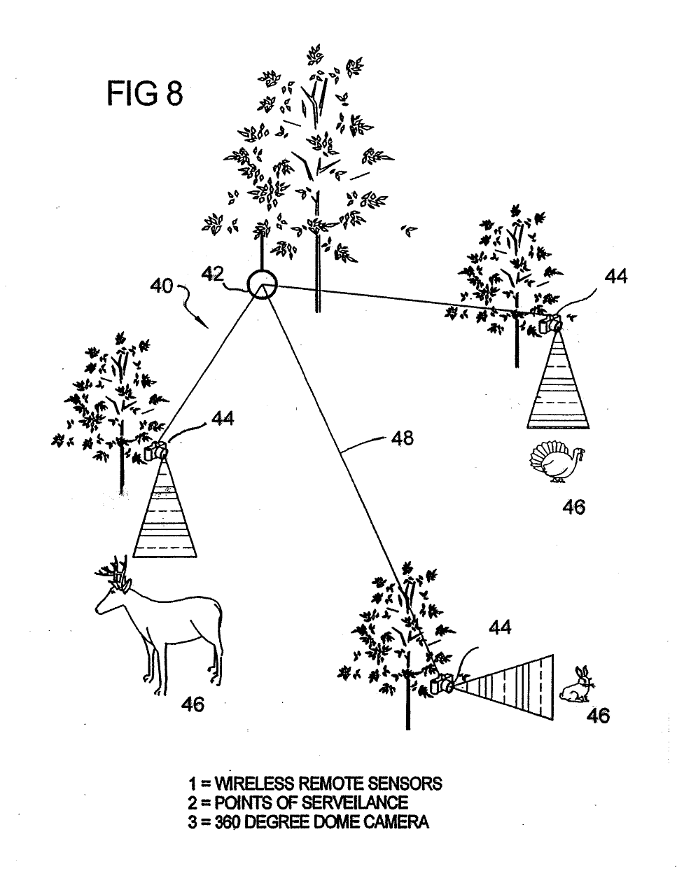

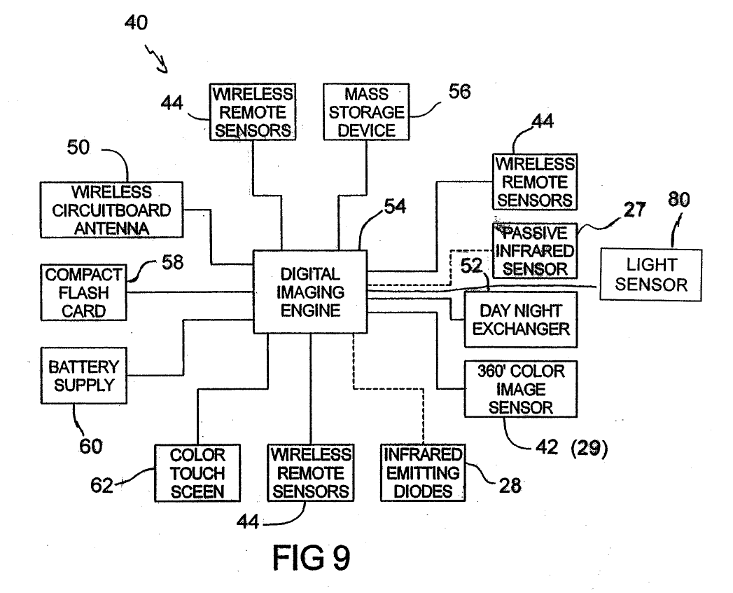

FIGS. 8 and 9 illustrate a second camera system 40 in accordance with a second embodiment which uses a 360-degree dome camera 42 and wireless remote sensors 44 in the vicinity of points of surveillance 46.

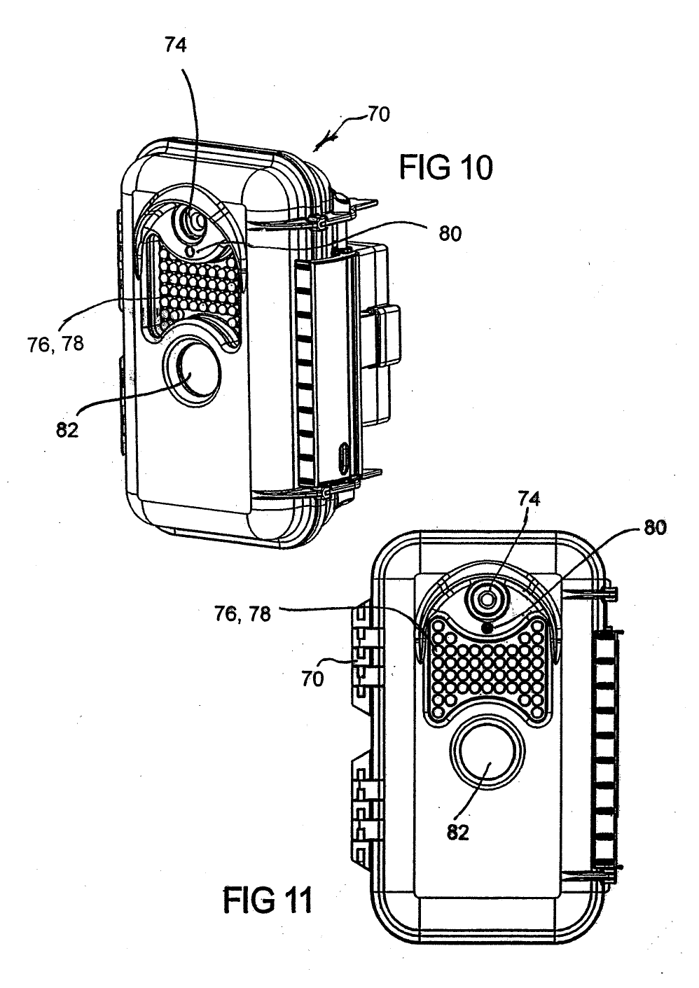

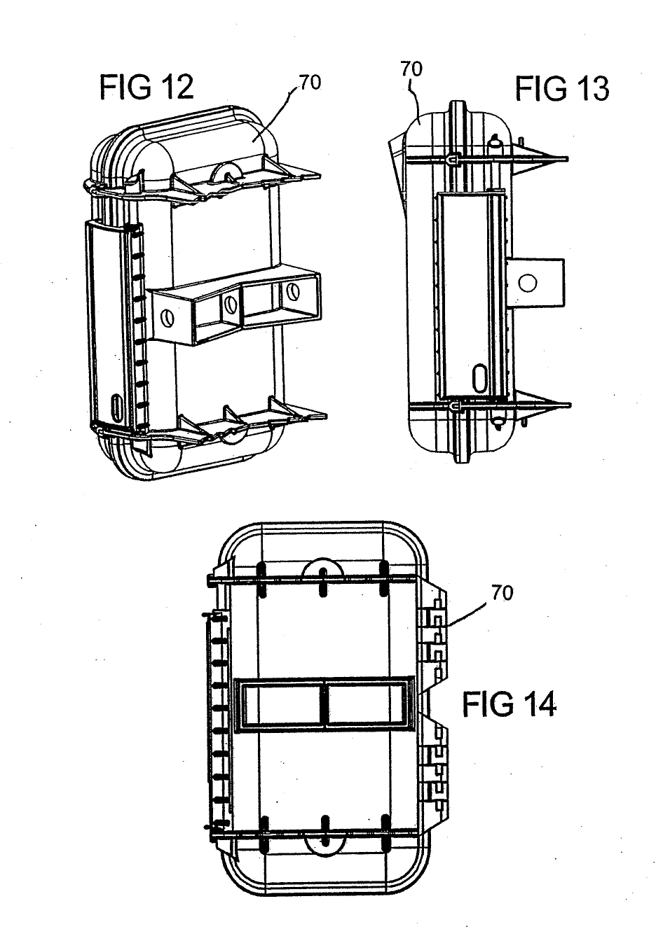

The third camera apparatus 70 of FIGS. 10-14 is similar in certain respects to the apparatus 20 shown in FIGS. 1-7. One difference is a case change to the front half of the apparatus to accommodate the mixed IED arrangement described hereinabove.

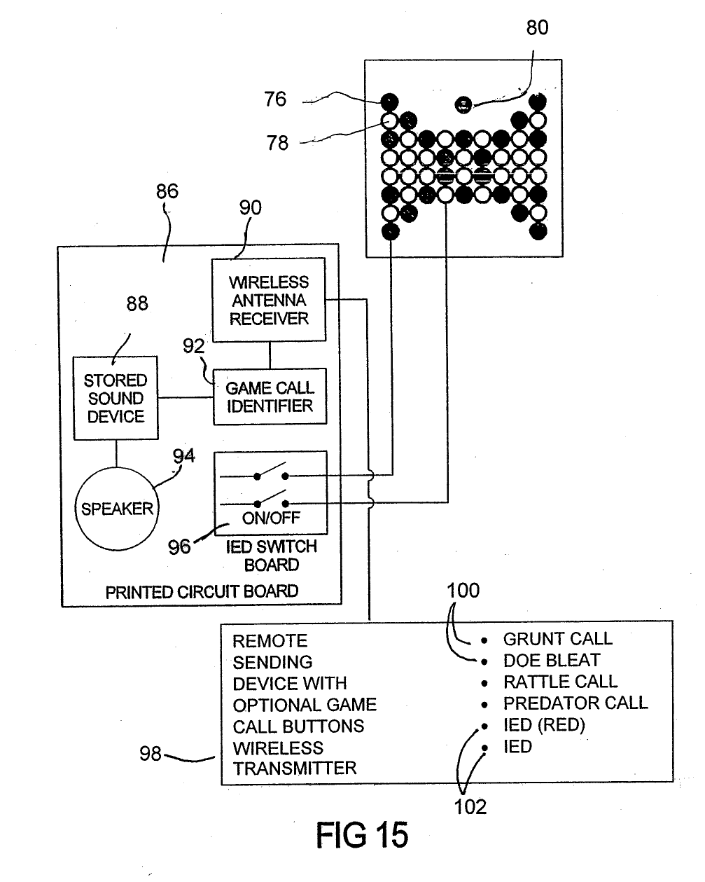

FIG. 15 shows that cameras 20, 40 and 70 may include a built-in game call identifier 86 inside the camera system which the user can activate from anywhere, such as from a tree stand or elevated location with the remote device 98.

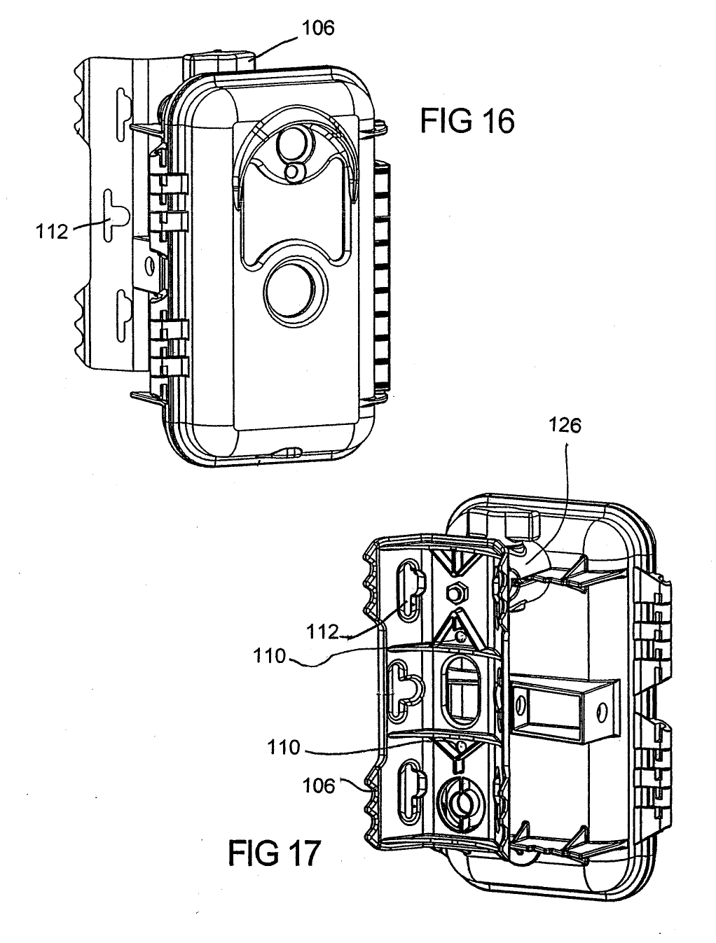

The novel tree bracket 106 shown in FIGS. 16-27 can be used to hold cameras 20, 40 and 70, a battery 142, a solar panel or other accessories.

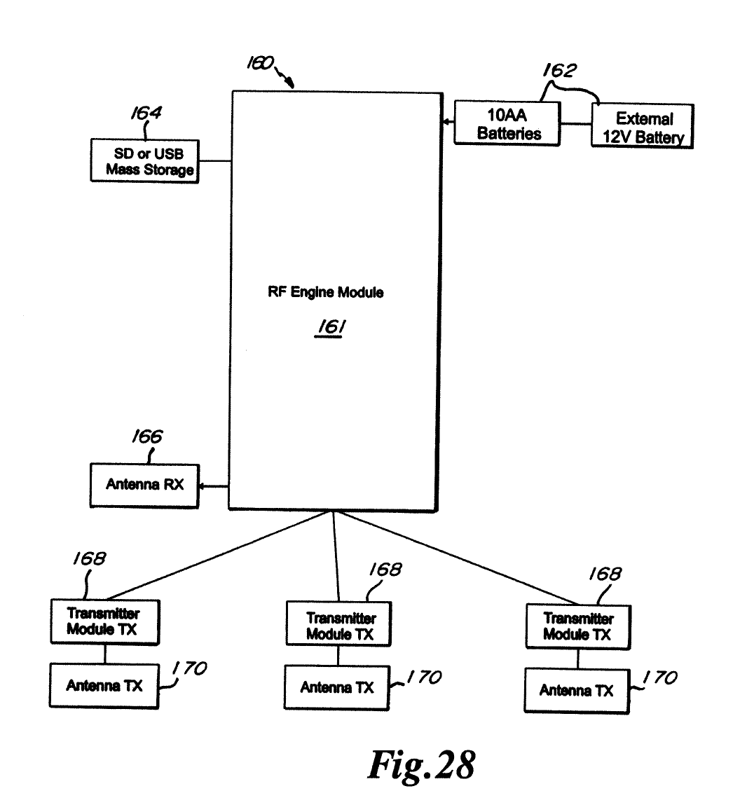

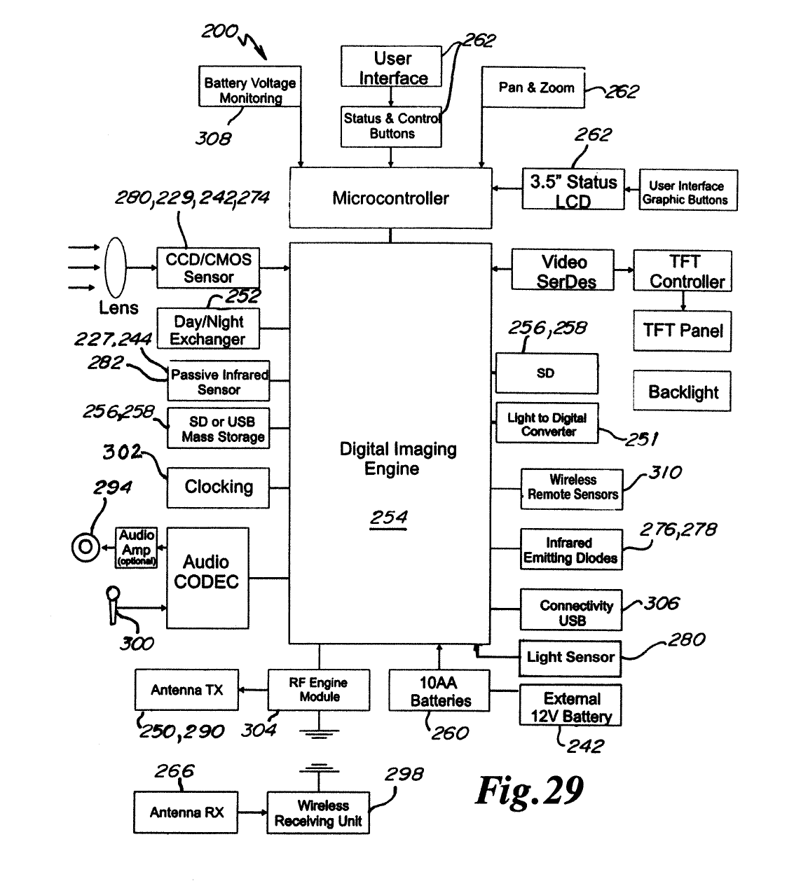

With reference to FIG. 28 there is shown a self-contained receiving device 160 to be used with first 20, second 40, third 70 and fourth 180 cameras for receiving images and videos from these systems. The receiving device 160 may readily be mounted on an external structure, for example, on a tree, or may be hand held. The device 160 may be in a water-tight case similar to case 21 and includes a hinge 22 and a gasket 23.

FIG. 29 is a schematic of the fourth embodiment of the RF surveillance camera system 200.

With reference to FIGS. 1-7, there is shown a self-contained surveillance camera system 20. The apparatus 20 is complete and ready for mounting, for example, on a tree or post. Preferably, but not necessarily, the apparatus 20 may be camouflaged. The apparatus 20 includes a water-tight case 21 with a hinge 22 and a gasket 23. The rear side of the apparatus 20 is provided with a V-shaped locking structure 24 including special brackets 25 to facilitate its mounting. The locking structure 24 serves as a portable/moveable locking device for securing the apparatus 20 to an external object, such as tree or post with a lockable cable through cable apertures 26 in bracket 25.

As shown in FIGS. 3 and 9, the first surveillance camera apparatus 20 is provided with Perkin Elmer LHi 968 a passive infrared sensor 27 and with a combination of either but not limited to Osram Golden Dragon Super Hi-Output sfh 4231 940 Nm or Vishay tsal 6100 940 Nm infrared emitting diodes 28. The passive infrared sensor 27 emits a constant signal beam, and senses heat in motion. When this occurs, the passive infrared sensor 27 signals to, but not limited to, Vista Imaging ViaCam III the digital imaging engine 54 to activate the infrared emitting diodes 28 to illuminate the object only if it is dark, and have the color image sensor camera 29 photograph the object. Thus, the passive infrared sensor 27 detects heat in motion, which in turn signals the camera 29 and allows it to take clear photos of the object which is generating the heat in motion

Preferably, but not necessarily, the camera system 20 shown in FIGS. 1-7 may use either or a combination of Osram sfh 4231 or Vishay Tsal 6100 infrared emitting diodes (LEDs). These diodes may range from 900 nm-950 nm type (but are not limited to color or dispersion angle) which is a very high frequency and emit virtually no red light that the human eye can see. These are excellent for security, and they do not alert animals that there is a camera in the area. The distance may be limited compared to lower wave length Vishay TSHG 8200, 830 Nm infrared emitting diode which emit a bright red glow. Some users favor/demand the stealth no-light LEDs, but other users favor/demand a system/apparatus which accomplishes “seeing” more distance even it means using a lower wave length IED that emits some visible red light. The camera system 70 shown in FIGS. 10-15 satisfies both of the aforementioned demands.

FIGS. 8 and 9 show the second embodiment camera 40 with external sensors 44. Each wireless remote sensor 44 sends an infrared transmission signal through a lens. Preferably, but not necessarily, the lens may be a Fresnel 0.65 plano convex 0.015 thick poly lens.

The signal is thereby configured into a conical array which is the heat-in-motion detection zone. When heat radiation in motion (which may be caused by, for example, a person or animal) enters this detection zone, communication signal 48 is sent from a wireless remote sensor 44 to a wireless circuit board antenna 50. This signal then dictates the direction of the object to be photographed, and causes the 360-degree color image sensor or dome mounted camera 42 to rotate to face in the direction of the object and photograph it. Camera 42 may be a Sony ⅓ format Hi-Resolution image sensor with Hi-Speed 360 degrees pan and tilt, Hi-Sensitivity low light 0.05 Lux, Fixed 3.6 mm lens Hi-Resolution 480 TV lines.

Before any images can be taken, a light sensing device called the TAOS TSL 2560 Digital to Light convertor 51 must first recognize what the current light conditions are and then sends the proper signal to the Vista Imaging Via Cam III image processor or engine 54. For example if it bright day light the TSL 2560 light sensor 51 will send a signal not only to place the Sunex day/night exchanger 52 in the proper position but it will also send a signal not to activate the infrared emitting diodes 28. The same is true if it is low light or night time conditions, it will send a signal to switch the day/night exchanger 52 and also activate the infrared panel 28. This way we are certain that clear crisp images are received through but not limited to an optional 1× to 4× (power) Sunex DSL 914 52 degree viewing angle high-resolution four element glass lens on camera 42 (or 29). Preferably, but not necessarily, these optional lens assemblies may be threaded into a Sunex M12-EXM-IRC21 miniature day/night exchanger 52 that covers, preferably, an Aptina MT9P001 3 mp ½ color image sensor 42 (or 29) along with the day/night exchanger 52 which permits the taking of true day/night photographs.

The mass storage device(s) 56 may include, but are not limited to, a sd, compact flash card 58 or an USB jump drive. The USB mass storage device 56 is preferred, and is uniquely used as a host and not as a slave. This means that it can store information, still photographs, and/or video, and then be plugged directly into an USB port of a computer to download the stored information, etc.

The camera system 40 is preferably provided with a Densitron 3.5 diagonal 320 RGB X 240H color touch screen 62 which can be used to view photos, video, pan, tilt and digitally zoom, and can also be used to set and control all the system functions and settings stored and given from the Vista Imaging ViCam III digital imaging engine (processor) 54 by touching selected grid areas within the color touch screen 62.

The digital imaging engine or processor 54 also controls and selects which device the images will be stored in. One option, which is most preferred, is the USB mass storage device 56 (jump/flash drive) port. The other storage device which is secondary is a sd or compact flash card (CF) 58. The engine 54 also signals and controls the day/night exchanger sensor 51 for night and day photos, sends information to and receives commands from the color touch screen 62, and sends and receives signals to the RF offsite receiving unit 160 (FIG. 28) and also from the wireless remote sensors 44. A battery supply 60 furnishes power to the camera system 40 and other components.

The third embodiment camera system 70 of FIGS. 10-14 adds more infrared emitting diodes 76 of a lower frequency in the 830 nm to 890 nm (not limited to color, angle or wave length) range. These diodes 76 will emit a very small amount of red light that the human eye can see. These diodes 76 are mixed in with the 900 nm-950 nm (not limited to any specific color or angle) diodes 78 which emit virtually no red light that the human eye can see, using two different circuits. One circuit operates the 830 nm-890 nm diodes 76, and another circuit operates the 900 nm-950 nm diodes (not limited to a specific color or angle) 78. System apparatus 70 can also use a mixed combination of diodes 76 and 78 Osram SFH 4231 940 nm Golden Dragon surface mount and also Vishay TSAL 6100 940 nm through hole but limited to any specific angle or color. The user will have the option with this combination that emits virtually no red light that the human eye can see and also can control the night distance by controlling the amount voltage sent to the leds by way of the settings listed on the touch screen.

Either of the above arrangements gives the user the option of using virtually no light that the human eye can see by activating only the 900 nm-950 nm diodes (but not limited to a specific color or angle) 78. Or if the user wants the extended distance of approximately 60 feet, then the user can operate both the 900 nm-950 nm diodes 78 and the 830 nm-890 nm diodes 76 at the same time or they increase or decrease the voltage using the touch screen settings via a switch 102 (see FIG. 15) in the system.

With reference to FIGS. 10-14, there is shown the self-contained surveillance apparatus 70 which does not require remote sensors. The apparatus 70 is complete and ready for mounting, for example, on a tree or post. Preferably, but not necessarily, the apparatus 70 may be camouflaged. The apparatus 70 includes a water-tight case 72 with a hinge 45 and a gasket 46. Most of the components described above with reference to FIGS. 1-9 are enclosed within the case 72. The rear side of the apparatus 70 is provided with a V-shaped locking structure 24 including special brackets 25 to facilitate its mounting. The locking structure 24 serves as a portable/moveable locking device for securing the apparatus 70 to an external object, such as tree or post.

The apparatus 70 is provided with a Perkin Elmer LHi 968 passive infrared sensor 82. The passive infrared sensor 82 emits a constant signal beam, and senses heat in motion. When this occurs, the passive infrared sensor 82 signals the digital imaging engine (similar to 54) to activate the infrared emitting diodes 76 and 78 to illuminate the object and have the color image sensor/camera 74 photograph it. Thus, the passive infrared sensor 82 detects heat in motion, which in turn signals the camera 74 and allows it to take clear photos of the object which is generating the heat in motion

The apparatus also includes a light sensor TAOS TSL 2560 80 (FIGS. 10-15) which is a light to digital convertor that senses the ambient light conditions. The light sensor 52 presets the color image sensor or camera 74 before it “wakes up” for motion activation from the passive infrared sensor 82. The color image sensor 74 thereby already knows the ambient light conditions and has already been pre-focused. This allows for faster trigger speeds and better image quality. For example, when a person walks from inside a dark building and out into bright sunlight, it takes some time to adjust to the sunlight. The sensor 82 does such an adjustment very quickly, for example, in approximately 0.3 tenths of a second.

Apparati 20, 40 and 70 can also be used to send pictures and video directly to a RF stationary or mobile receiving unit apparatus 160 where they can be retrieved later. Apparati 20, 40 and 70 are also equipped with a built in tracking device. This device will notify the owner exactly when said apparatus was moved and also where it has been moved to. For example when said apparatuses are in a stationary position the moment they are moved the owner of said apparatus will be notified but not limited to either ring tone or a call to a cell phone or to the hand held device apparatus 98. Each apparatus will have its own call number or name that the user can set to identify which camera has been moved if multiply cameras are in use at the same time. Also this system will allow the user to track the camera whether it remains moving or becomes stationary again.

The touch screen may be TCC LCD module: SYB 1602A Charger 16×2 and will also be used to select and activate various game call options e.g., Buck Grunt Call, Buck Rattling Horns, Doe bleat, one or more Predator calls, etc. These different options are activated by separate menu screen buttons 100 which the user can activate separately or as needed. The different sounds are stored on a stored sound device 88, possibly on the USB storage.

The system can include the wireless remote system 160 (FIG. 28) so the user can communicate with the apparati 20, 40 and 70 to retrieve and view pictures and video from long distances also when the user wishes to use or stop the game call. Preferably, but not necessarily, the transmitter 98 (FIG. 15) can be in the form of preferable but not necessarily a hand held device, a wrist watch or a device that attaches to clothing or a hunting apparatus. An inside or outside speaker 98 can be used. Preferably, but not necessarily, the sounds may be stored on the USB jump drive that plugs into the system, and played back from there through the system.

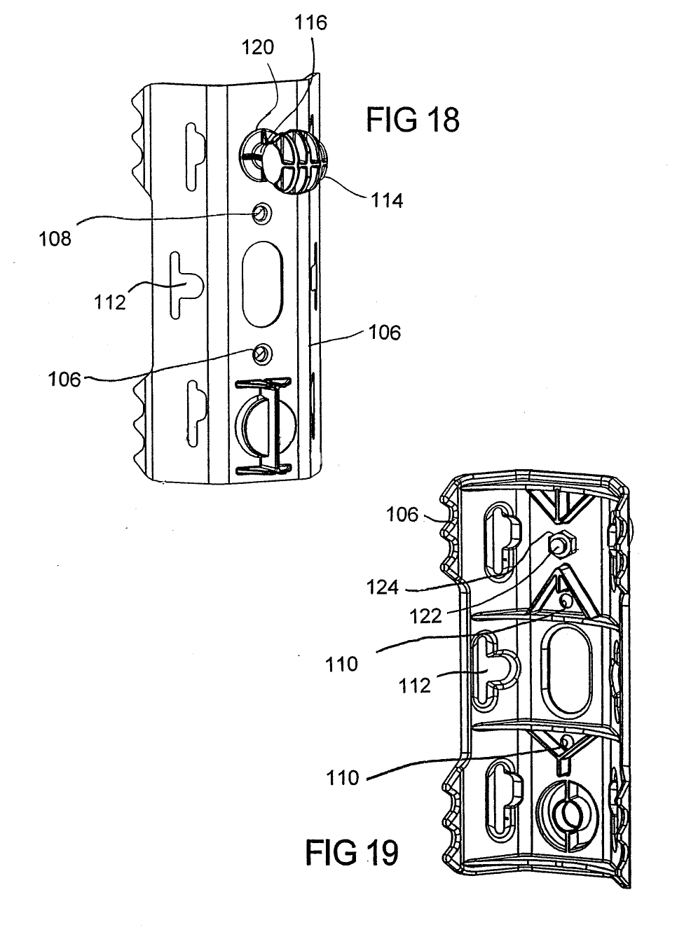

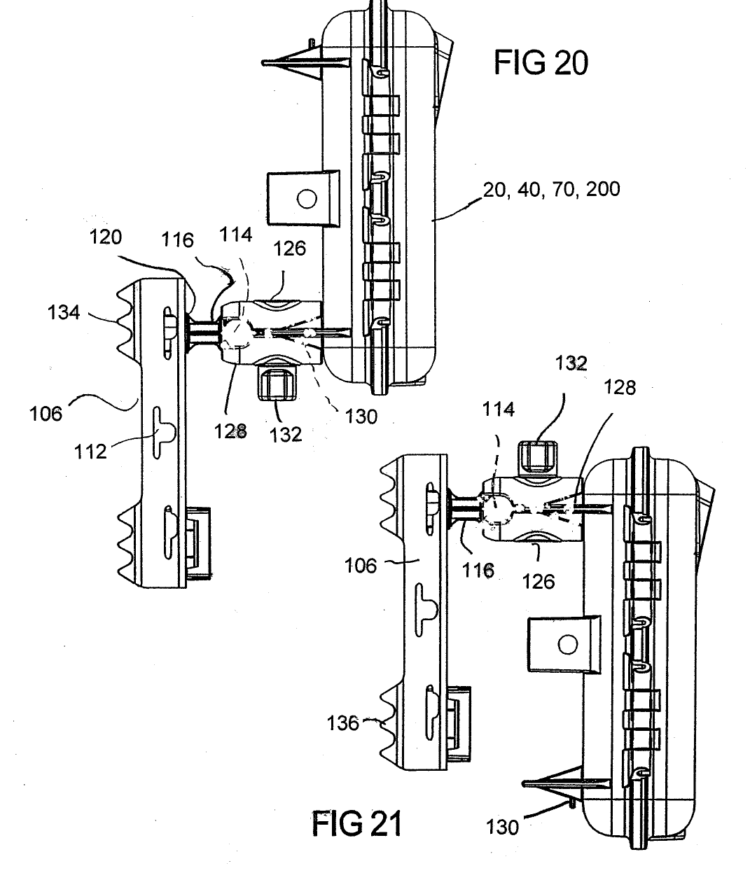

Tree mounting bracket 106 is shown in FIGS. 16-27. U-shaped bracket 106 can be secured to a tree with fasteners 108 placed through screw holes 110 into the tree and/or by straps passing through the two strap slots 112 and/or the four strap/battery cap hanger slots 150. As shown in the FIGS. 18-21, a ball mount 114, a ball and socket interface 126, an attachment clamp 128, a clamp attachment 128 for a camera 20, 40 or 70, a camera mounting bracket 130, and a clamp tightener 132 are provided. These components, combined with the novel bracket 106, allow various degrees of movement needed to mount to anything at any angle. The ball mount 114 is provided with a threaded portion 116 at and near its end 118 coming out from the back of a round pad 120, and can be screwed into the back of different camera models. In FIGS. 20 and 21 the end 118 of the ball mount 114 is shown fastened to bracket 106 via a threaded bolt 122 and nut 124. Bracket 106 has four cleats 134 which dig into the tree.

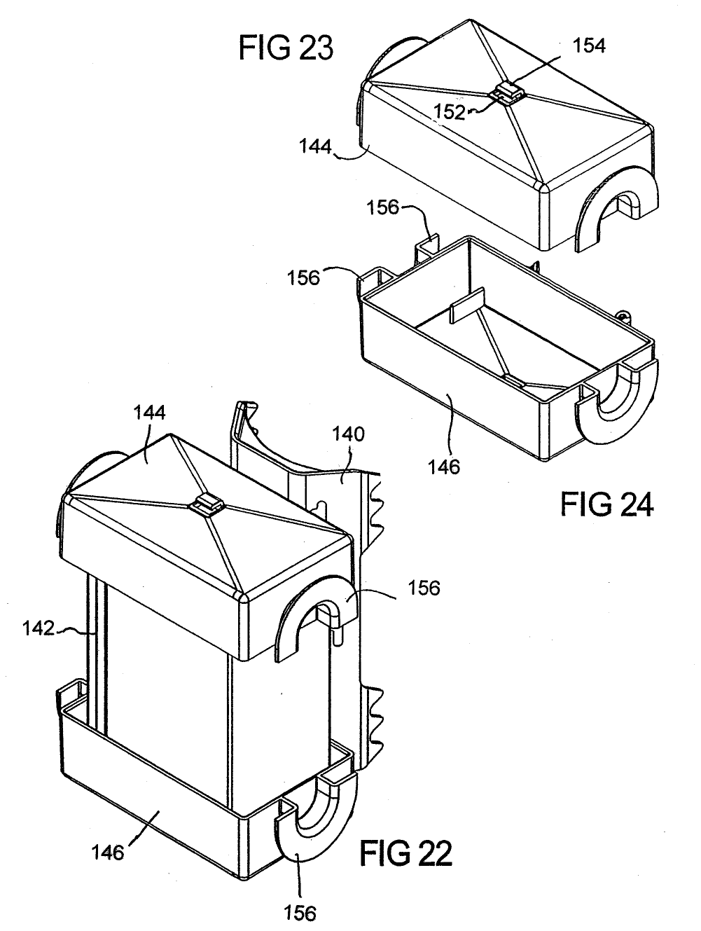

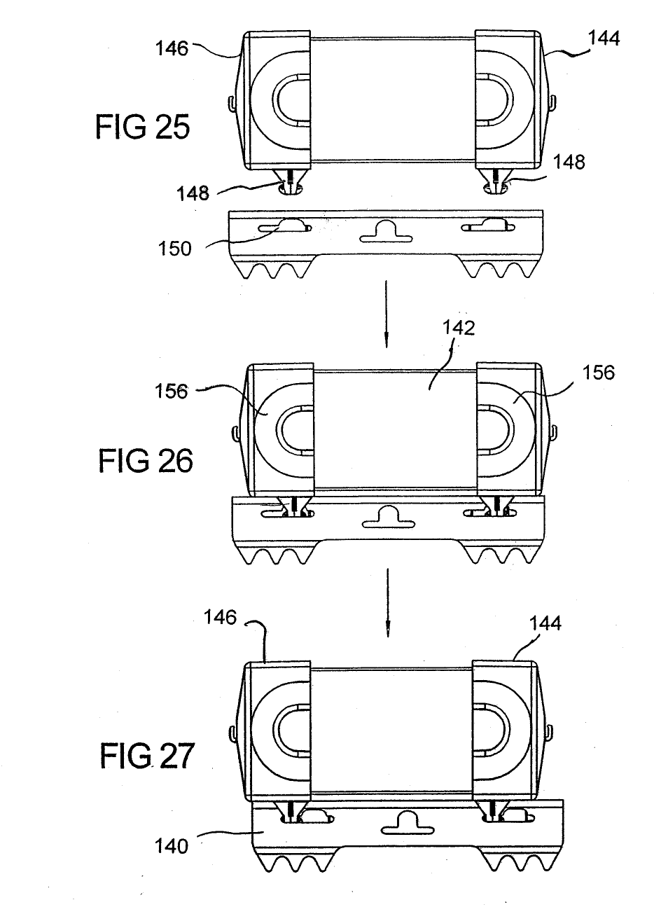

With reference to FIGS. 22-27, there is shown a battery tree bracket 140, the battery 142, and top and bottom battery caps 144 and 146. Top cap 144 has two hanging tabs 148, and bottom cap 146 has two hanging tabs 148. FIGS. 25-27 show the sequence of interlocking the tabs 148 into and with the four strap/battery cap hanger slots 150 in bracket 140. Top cap 144 has a drain hole 152 and a cord pinch tab 154. Caps 144, 146 have excess cord winding/elastic device attachment tabs 156.

FIG. 28 shows a RF receiver 160 which is remote from the cameras 20, 40 and 70. A printed circuit board (part of the apparatus 160) has, but is not limited to, Synapse RF Engine module 161, storage devices 164 but not limited to sd, cf and USB, MINI-GSM 900/1800 MHz antenna 166, battery or external power supply 162. These images and videos can either be sent from cameras 20, 40 and 70 to a RF receiver 160 where they can be retrieved later, or they can be viewed and retrieved directly from cameras 20, 40 and 70.

The touch screen 98 will also be used to select and activate various game call options e.g., Buck Grunt Call, Buck Rattling Horns, Doe bleat, one or more Predator calls, etc. These different options are activated by separate menu screen buttons 100 which the user can activate separately or as needed. The different sounds are stored on a stored sound device 63, possibly on the USB storage.

As shown in FIG. 29, a fourth embodiment includes a RF surveillance camera system 200. Camera system 200 utilizes infrared sensors 227, 244, 282. Components previously called out and numbered now start with a “2” in front of them for easy back reference where applicable.

Camera system 200 utilizes IEDs 276, 278; circuit board antenna 250, 290; memory 256, 258; day/night exchanger 252; batteries 260, 242; digital imaging engine 254, camera 229, 242, 274; color touch screen 262; speaker 294; remote device 298; antenna 266; passive infrared sensors 227, 244, 282; wireless remote sensor 280.

Some additional advantages of system 200 are audio pick up microphone 300, a clock 302, a RF engine module 304, a USB port 306, battery monitor 308. A microcontroller 310 manages camera system 200. A LISA miniature lens by Ledid O4 may also be used to defuse the IEDs.

Camera system 200 operates by light sensor 280 setting the day/night exchanger and controlling the on/off IEDs 276, 278 previously set by the user on LCD screen 262 or with wireless receiving unit 260, 298. The passive infrared sensor 227, 244, 282 detects an animal moving in front of camera system 200.

A photo or video is next taken through camera 229, 242, 274 as previously set by the user. The picture/video is then stored in the mass storage 256, 258 previously selected by the user. Alternatively, the user may retrieve the image with the wireless receiving unit 298.

The importance of sending these images and videos with sound to an offsite storage location should be noted. If the cameras 20, 40, 70, 200 that are currently taking those images become stolen or vandalized the image and voice recognition of the person or persons involved will have already been sent and stored in this offsite location for later prosecution and possible conviction.

There have been illustrated in the accompanying drawings and described herein above several of the unique and novel embodiments of the present invention which can be practiced and constructed in many different configurations, arrangements of components, sizes, and shapes. It should be understood that many changes, modifications, variations, and other uses and applications will become apparent to those persons skilled in this particular area of technology and to others after having been exposed to the present patent specification and accompanying drawings. Any and all such changes, modifications, variations and other uses and applications which do not depart from the spirit and scope of the present invention are therefore covered by and embraced within the present invention and the patent claims set forth herein below.

1. A self-contained surveillance apparatus, comprising:
(a) a water-tight case;
(b) a 360-degree dome camera mounted in said case;
(c) a digital imaging engine mounted in said case;
(d) a battery supply mounted in said case;
(e) a RF engine module
(f) one or more infrared diodes mounted in said case;
(g) one or more passive infrared sensors mounted in said case;
(h) a wireless circuit board antenna mounted in said case;
(i) a mass storage device mounted in said case;
(j) a day/night exchanger mounted in said case;
(k) a sd or compact flash card mounted in said case; and
(l) said digital imaging engine being operable connected to said camera, said battery supply, said infrared diodes, said passive infrared sensors, said antenna, said RF Engine Module said mass storage device, said day/night exchanger, and said compact flash card; and
whereby said camera is caused to rotate to face in the direction of an external object to be photographed by said camera.

2. An apparatus according to claim 1, wherein:
(a) said dome camera includes a 360-degree color image sensor;
(b) said color image sensor is operable connected to said day/night exchanger to enable said camera to take true day/night photographic images; and
(c) said images are stored in said mass storage device where they can be viewed and edited when desired.

3. A self-contained surveillance apparatus that does not require remote sensors, comprising:
(a) a water-tight case;
(b) a camera mounted in said case;
(c) a digital imaging engine mounted in said case;
(d) a battery supply mounted in said case;
(e) one or more infrared diodes mounted in said case;
(f) one or more passive infrared sensors mounted in said case;
(g) a light sensor mounted in said case;
(h) a RF engine module;
(i) a wireless antenna mounted in said case;
(j) a mass storage device mounted in said case;
(k) a day/night exchanger mounted in said case;
(l) a sd or compact flash card mounted in said case;
(m) said digital imaging engine being operable connected to said camera, said battery supply, said infrared diodes, said passive infrared sensors, said antenna, said RF engine module said mass storage device, said day/night exchanger, and said sd or compact flash card;
(n) whereby said camera is enabled to take a photographic image of an external object entering a heat-in-motion detection zone.

4. An apparatus according to claim 3, wherein said infrared diodes comprise a diode cluster including one or more first infrared emitting diodes which emit virtually no light that the human eye can see and one or more second infrared emitting diodes which emit a very small amount of light that the human eye can see.

5. An apparatus according to claim 3, wherein said infrared diodes comprise a diode cluster including one or more first infrared emitting diodes which emit no visible light and one or more second infrared emitting diodes which emit some visible light.

6. An apparatus according to claim 3, wherein:
said infrared diodes comprise a diode cluster including one or more first infrared emitting diodes which emit no visible light and one or more second infrared emitting diodes which emit some visible light.

7. An apparatus according to claim 3, including:
(a) a complete RF receiving system mounted in said case;
(b) a RF receiving antenna used for retrieving signals between said devices
(c) a RF engine module which is used for receiving images and videos which are stored to said storage devices
(d) said internal and external battery supply.

8. An apparatus according to claim 3, including:
(a) a complete RF receiving system mounted in said case;
(b) a RF receiving antenna used for retrieving signals between said devices
(c) a RF engine module which is used for receiving images and videos which are stored to said storage devices
(d) said internal and external battery supply;
(e) a game calling device mounted in said case;
(f) said game calling device includes a speaker through which animal calls can emanate; and
(g) said game calling device can be activated remotely by a wireless transmitter which is also used for viewing and retrieving pictures and videos.

9. An apparatus according to claim 3, including:
a complete RF receiving system mounted in said case;
a RF receiving antenna used for retrieving signals between said devices
a RF engine module which is used for receiving images and videos which are stored to said storage devices
said internal and external battery supply;
a game calling device mounted in said case;
said game calling device includes a speaker through which animal calls can emanate; and
said game calling device can be activated remotely by a wireless transmitter.
which is also used for viewing and retrieving pictures and videos.

10. An apparatus according to claim 4, including:
a complete RF receiving system mounted in said case;
a RF receiving antenna used for retrieving signals between said devices
a RF engine module which is used for receiving images and videos which are stored to said storage devices
said internal and external battery supply.
a game calling device mounted in said case;
said game calling device includes a speaker through which animal calls can emanate; and
said game calling device can be activated remotely by a wireless transmitter.
which is also used for viewing and retrieving pictures and videos.

11. An apparatus according to claim 5, including:
a complete RF receiving system mounted in said case;
a RF receiving antenna used for retrieving signals between said devices
a RF engine module which is used for receiving images and videos which are stored to said storage devices
said internal and external battery supply;
a game calling device mounted in said case;
said game calling device includes a speaker through which animal calls can emanate; and
said game calling device can be activated remotely by a wireless transmitter.
which is also used for viewing and retrieving pictures and videos.

12. An apparatus according to claim 6, including:
a complete RF receiving system mounted in said case;
a RF receiving antenna used for retrieving signals between said devices
a RF engine module which is used for receiving images and videos which are stored to said storage devices
said internal and external battery supply.

13. An apparatus according to claim 4, including:
circuit switching means electrically connected to said first and second infrared emitting diodes to enable a user of said apparatus to use only said first light emitting diodes which emit no visible light, or to use simultaneously both said first light emitting diodes which emit virtually no visible light and second infrared emitting diodes which emit some visible light. Or the option of using a combination of said light emitting diodes that emit virtually no visible light and adjusting the current by said user interface touch screen to control the night distance

14. An apparatus according to claim 5, including:
circuit switching means electrically connected to said first and second infrared emitting diodes to enable a user of said apparatus to use only said first light emitting diodes which emit no visible light, or to use simultaneously both said first light emitting diodes which emit no visible light and second infrared emitting diodes which emit some visible light. Or the option of using a combination of said light emitting diodes that emit virtually no visible light and adjusting the current by said user interface touch screen to control the night distance

15. An apparatus according to claim 6, including:
circuit switching means electrically connected to said first and second infrared emitting diodes to enable a user of said apparatus to use only said first light emitting diodes which emit no visible light, or to use simultaneously both said first light emitting diodes which emit no visible light and second infrared emitting diodes which emit some visible light. Or the option of using a combination of said light emitting diodes that emit virtually no visible light and adjusting the current by said user interface touch screen to control the night distance

16. An apparatus according to claim 7, including:
circuit switching means electrically connected to said first and second infrared emitting diodes to enable a user of said apparatus to use only said first light emitting diodes which emit no visible light, or to use simultaneously both said first light emitting diodes which emit no visible light and second infrared emitting diodes which emit some visible light. Or the option of using a combination of said light emitting diodes that emit virtually no visible light and adjusting the current by said user interface touch screen to control the night distance

17. An apparatus according to claim 1, wherein:
said case has a rear side provided with a V-shaped locking structure for quick release and selectively mounting the apparatus to an external structure;
said digital imaging engine controls and signals said day/night exchanger for night and day photographic images;
said digital imaging engine receives signals from external wireless remote sensors; and
said digital imaging engine controls storing said photographic images in said mass storage device or in said sd or compact flash card.

18. An apparatus according to claim 3, wherein:
said case has a rear side provided with a V-shaped locking structure for quick release and selectively mounting the apparatus to an external structure;
said digital imaging engine controls and signals said day/night exchanger for night and day photographic images; and
said digital imaging engine controls storing said photographic images in said mass storage device or in said sd or compact flash card.

19. A surveillance system, comprising:
one or more wireless remote sensors which each send an infrared transmission signal configured into a separate conical array forming a heat-in-motion detection zone;
a surveillance apparatus having a 360-degree dome mounted camera;
wireless transmission means for transmitting a signal from said remote sensor to said apparatus indicative of an external object entering said detection zone; and
means in said apparatus causing said camera to rotate to face in the direction of the object and to photograph the object.

20. A system according to claim 19, wherein said apparatus, comprises:
a water-tight case;
a 360-degree dome camera mounted in said case;
a digital imaging engine mounted in said case;
a battery supply mounted in said case;
one or more infrared diodes mounted in said case;
one or more passive infrared sensors mounted in said case;
a wireless antenna mounted in said case;
a mass storage device mounted in said case;
a day/night exchanger mounted in said case;
a sd or compact flash card mounted in said case; and
said digital imaging engine being operable connected to said camera, said battery supply, said infrared diodes, said passive infrared sensors, said antenna, said mass storage device, said day/night exchanger, and said compact flash card; and whereby said camera is caused to rotate to face in the direction of the external object to be photographed by said camera.
